(19) United States
(12) Patent Application Publication
(10) Pub. No.: US 2004/0196359 A1
(43) Pub. Date: Oct. 7, 2004

(54) Video conferencing terminal apparatus with part-transmissive curved mirror

(76) Inventor: Geoffrey Howard Blackham, Keymer Hassocks (GB)

Correspondence Address: Iandioro & Teska, 260 Bear Hill Road, Waltham, MA, 02451-1018, US

(21) Appl. No.: 10/485,013

(22) PCT Filed: May 12, 2002
(86) PCT No.: PCT/GB03/02027

(30) Foreign Application Priority Data
May 28, 2002 (GB) 0212299.2

(51) Int. Cl. H04N 7/14; G09G 5/00

(52) U.S. Cl. 348/14.08; 348/14.13; 345/179

(57) ABSTRACT

Apparatus for use in video conferencing, which apparatus comprises at least one video camera (50) for providing a video image signal of at least one person taking part in a video conference, at least one display means (46) on which the video image signal from a remote location is displayed, and at least one part-transmissive curved mirror (48) which enables the person to view the display means (46) with the video camera (50) being positioned on a side of the part-transmissive curved mirror (48) away from the person and at substantially eye level of the person, whereby persons using the apparatus for a video conference arc able to maintain eye contact with each other.

This invention relates to apparatus for use in video conferencing. The video conferencing can be any suitable and appropriate type of video conferencing.

Video conferencing is well known. It is a means by which persons can collaborate with each other visually and orally, whilst being physically separated from each other. The video conferencing may be accomplished over a variety of data links, for example video based telecommunications data links.

Apparatus for use in video conferencing requires audio equipment such for example as a microphone and a speaker, and video equipment such for example as a video camera and display means on which a signal from a remote video camera is able to be displayed. This audio and video equipment is required at each location where the video conferencing is to take place. Self-evidently, the apparatus for the video conferencing also requires transmitter means for transmitting appropriate data between the video conferencing equipment at the different locations. Compressed video can send information over the Internet or telephone networks, with the ability to share information such as by using data overlays, data bases or documents. Video conferencing can also be facilitated using broadcast, television, cable based television, or satellite communications.

One of the most important factors in video conferencing is eye contact between persons taking part in a video conference. Persons taking part in a video conference need to be able to see clearly reactions of other persons taking part in the video conference. Eye contact is essential for this. For example, eye contact can be used to regulate the flow of conversation. Persons can be invited to start conversing or speaking using eye contact. An indication of interest can be monitored using eye contact. Attention or interest can be conveyed with eye contact, lack of eye contact, or interruption of eye contact. The eyes are an important element on the human face for conveying emotion so that eye contact is an important factor in helping to convey emotions. Eye contact can be used to convey likes or dislikes, or to show intensity of feeling.

There are various types of known apparatus for use in video conferencing. Some of these known types of apparatus give poor eye contact. Other types of the known apparatus give eye contact but at the expense of the apparatus becoming over complex.

It is an aim of the present invention to obviate or reduce the above mentioned problems.

Accordingly, in one non-limiting embodiment of the present invention there is provided apparatus for use in video conferencing, which apparatus comprises at least one video camera for providing a video image signal of at least one person taking part in a video conference, at least one display means on which the video image signal from a remote location is displayed, and at least one part-transmissive curved mirror which enables the person to view the display means with the video camera being positioned on a side of the part-transmissive curved mirror away from the person and at substantially eye level of the person; whereby persons using the apparatus for a video conference are able to maintain eye contact with each other.

The apparatus of the present invention is able to provide many advantages over known apparatus for use in video conferencing. More specifically, with the apparatus of the present invention, it is possible to achieve eye contact in a one person to one person situation, in a one person to many persons situation, or in a many persons to many persons situation. The apparatus may enable virtual round table meetings to be conducted with eye contact. A plurality of pieces of the apparatus may be used to provide continuity between images, avoiding problems caused by overlapping planar images.

The apparatus may be one in which the display means is a curved screen.

The apparatus may be one in which the curved screen is a curved projection screen, and in which the apparatus includes a projector for projecting the signal from the remote video camera as a display onto the curved projection screen.

The apparatus may be one in which the curved projection screen is a curved rear projection screen, and in which the projector projects the display onto a concave side of the rear projection screen. Alternatively, the apparatus may be one in which the curved projection screen is a curved front projection screen, and in which the projector projects the display onto a convex side of the front projection screen.

The apparatus may include at least one light path fold mirror, and the apparatus may then be one in which the projector projects the display onto the curved projection screen via the fold mirror.

The apparatus of the invention may be such that there are more than one of the projectors.

If desired, the apparatus of the invention may be such that the display means is an emissive display means.

The display means may be a cathode ray tube monitor. Alternatively, the display means may be a flat panel display means. The flat panel display means may be a liquid crystal flat panel display device. Alternatively, the flat panel display means may be an organic light emitting polymer display panel.

The flat panel display device may be part of a lap top computer.

The flat panel display device may be a plasma display panel.

The apparatus may be one in which the display means extends continuously in a horizontal direction such that the display means subtends a wider angle at the person. Alternatively, the apparatus may be one in which the display means and the part-transmissive curved mirror both extend continuously in a horizontal direction such that a wider angle is subtended at the person. Alternatively, the apparatus may be one in which the part-transmissive curved mirror is extended continously in a horizontal direction such that the part-transmissive curved mirror subtends a wider angle at the person.

The apparatus may be one in which there are more than one of the display means, and in which the display means are arranged adjacent to each other and facing substantially away from the person.

The apparatus may be one in which two of the video cameras are positioned on the side of the part-transmissive curved mirror remote from the person, and in which the two video cameras are positioned with a horizontal separation such that a stereoscopic video image signal of the person is made.

The apparatus may include software for manipulating images such that the image of the person is provided with desired orientation and distortion correction.

The apparatus may include audio means for providing audio signals of the persons taking part in the video conference. The audio means may include a microphone and a speaker at each location. Any suitable and appropriate type of audio means may be employed.

The apparatus may include connection means whereby the visual displays are connected via a communications link providing means for transmitting audio and visual data between more than one of the display means, the communications link being provided by at least one local area network, a wide area network, multiple telephone lines, a high-speed data link, the Internet, an ISDN, or a wireless communications link.

The displays means may be a modular display means, whereby a plurality of the modular display means can be placed adjacent to each other in order to form an extended visual display.

Embodiments of the invention will now be described solely by way of example and with reference to the accompanying drawings in which:

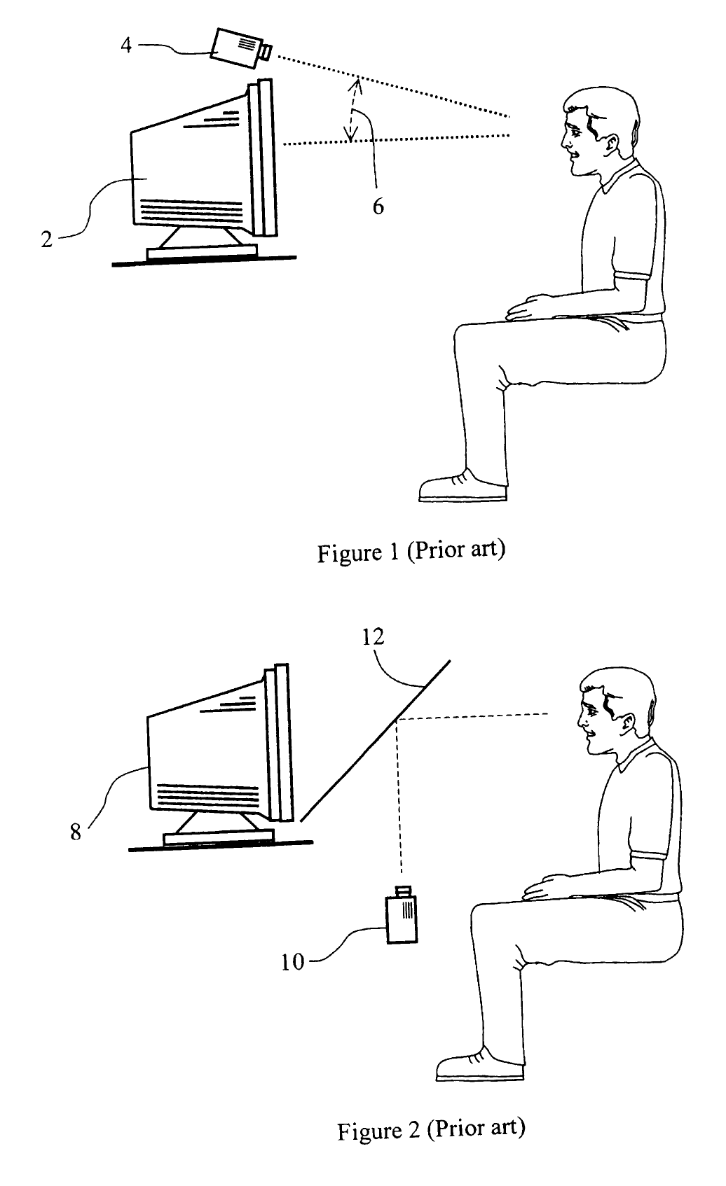

FIGS. 1 - 5 show different types of known apparatus for use in video conferencing; and

FIGS. 6 - 24 show different types of apparatus in accordance with the present invention for use in video conferencing.

Referring to FIG. 1, there is shown known apparatus for use in video conferencing. The apparatus includes a monitor 2 which is typically a computer monitor. A video camera 4 is placed on top of the monitor 2. The apparatus is such that it is restricted to one user at each location, and eye contact is poor because of the camera separation 6 from the monitor 2. This camera separation 6 also tends to increase with the use of large monitors 2.

FIG. 2 shows known apparatus for use in video conferencing which uses a monitor 8. A semi-transparent mirror 12 is placed at a angle of approximately 45° in front of the monitor 8. A video camera 10 is placed below the semi-transparent mirror 12, and therefore the video camera 10 sees a reflected image of the person. The person observes the monitor 8 through the semi-transparent mirror 12. Some of the light is lost in such an arrangement, the light being either transmitted or reflected by the semi-transparent mirror 12. The apparatus is also restricted to a single user at each location.

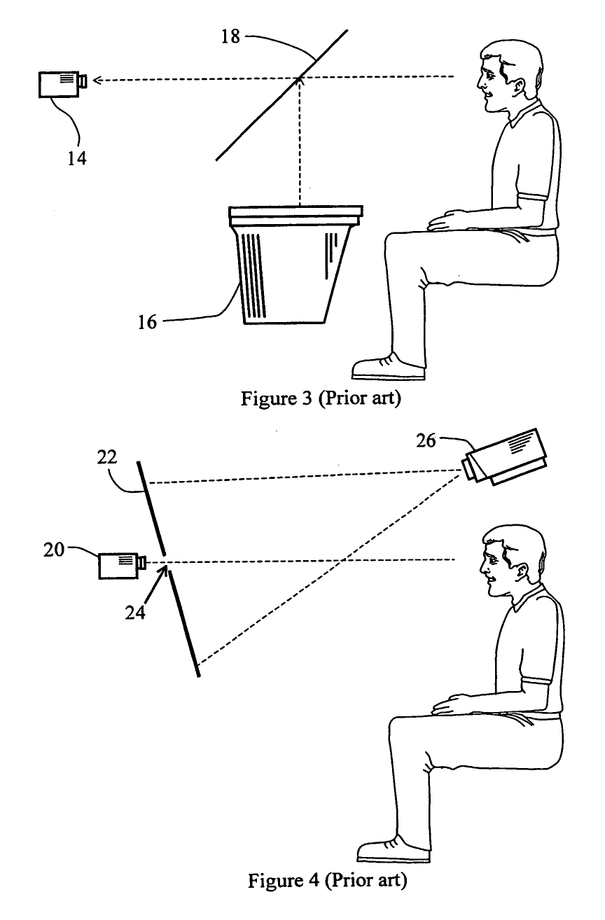

FIG. 3 shows known apparatus for video conferencing which uses a semi-transparent mirror 18, placed at an angle of approximately 45° to the illustrated person. A camera 14 is placed behind the semi-transparent mirror 18. A monitor 16 is placed below the semi-transparent mirror 18. The reflection of the monitor 16 is then able to be viewed by the person. Some light is lost in the apparatus shown in FIG. 3. The apparatus has been used to produce a three dimensional image of a person, especially in systems used in educational situations with a lecturer giving a talk from a remote location. Eye contact tends to reduce with more than one participant, and ambient light within a room can lead to deterioration of the image.

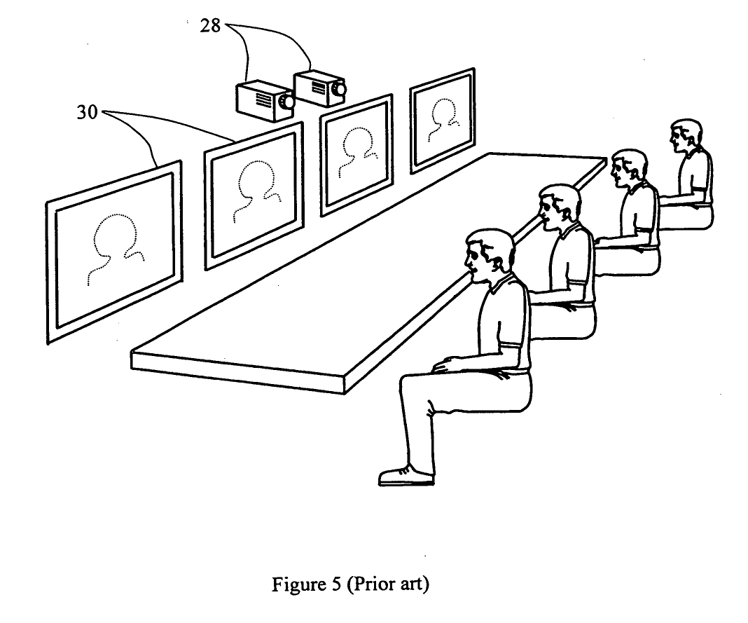

FIG. 4 shows known apparatus for use in video conferencing which achieves eye contact by using a space division approach. A camera 20 is placed behind a front projection screen 22, aligned with a small hole 24 in the front projection screen 22, thereby giving the video camera 20 a clear view of the illustrated person. A projector 26 is used to generate the image on the front projection screen 22. Some means is needed to prevent the video camera 20 seeing light output from the projector 26. This is usually achieved by keeping the projector 26 out of the field of view of the video camera 20.

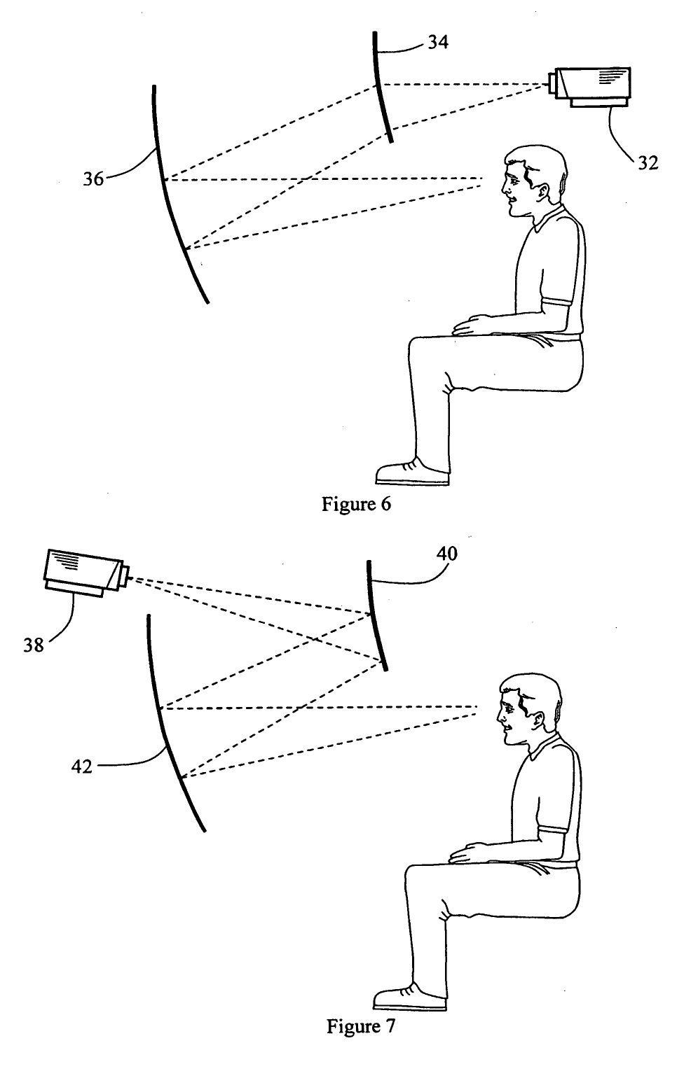

FIG. 5 shows known apparatus for use in video conferencing and which uses multiple large display screens 30 and cameras 28 mounted above the screens 30. The apparatus shown in FIG. 5 is designed to work around a table, giving the feeling of being in a meeting. The apparatus is such that the video cameras 28 are separated from the screens 30 and, since the display screens 30 are large, the separation is also large, leading to poor eye contact.

Referring now to FIGS. 6 - 24, there are shown different types of apparatus in accordance with the present invention for use in video conferencing.

FIG. 6 shows a typical layout for a tilted collimator with a curved image being viewed via a curved mirror. The image is projected from a projector 32 onto a curved rear projection screen 34. A person views the image via a curved mirror 36.

FIG. 7 shows apparatus for use in video conferencing in which a projector 38 projects an image onto a curved front projection screen 40. The person again views the screen 40 via a curved mirror 42. Alternatively, an emissive display, preferably curved, could be used as the display surface, replacing the projected image. The image viewed by the person in a tilted collimator appears at a distance that it typically significantly greater than the physical extent of the display hardware.

The apparatus of the present invention uses a part-transmissive curved mirror such that a proportion of the light from the participant in a video conference can pass straight through. One or more video cameras are placed behind the part transmissive mirror. The camera or cameras capture an image of the or each person taking part in the video conference. The cameras are positioned at a height that is substantially the same as the eye height of the person. The person is still able to view the projected image via the part-transmissive curved mirror.

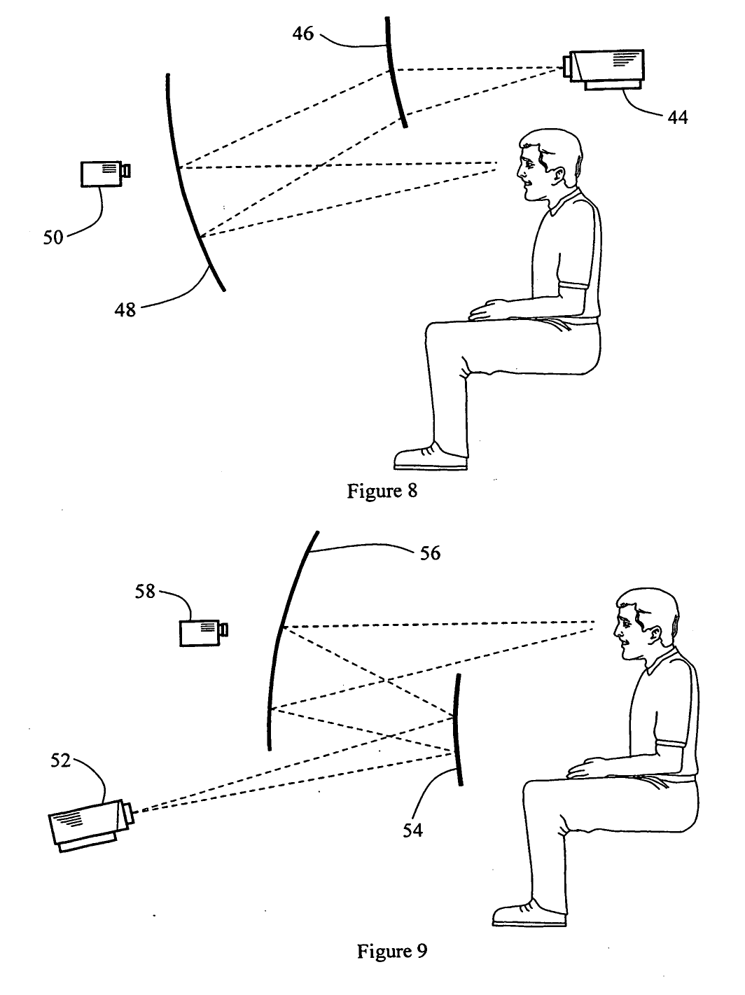

FIGS. 6 and 7 above illustrate part of the present invention, there being no video cameras shown. FIG. 8 shows in more detail apparatus of the present invention for use in video conferencing. In FIG. 8, there is shown apparatus for use in video conferencing, which apparatus comprises a projector 44 which projects an image onto a curved rear projection screen 46. The person in the video conference is able to view the image via a semi-transparent mirror 48. A camera 50, placed behind the part-transmissive curved mirror 48 and at the same level as the person's eye height, captures an image of the person through the part-transmissive curved mirror 48. The curvature of the part-transmissive curved mirror 48 means that the image that the person sees is collimated to a distance determined by the curvature of the mirror 48. Varying the mirror curvature enables the image to be displayed at varying magnifications and therefore to appear at varying distances. Another arrangement as shown in FIG. 8 is needed at each desired remote location. A suitable communications link between the two or more pieces of apparatus enables the participants to take part in a video conference. If the cameras and displays work continuously and in real time, natural conversation is possible between the participants, including appreciation of gestures and body language, as the positioning of the cameras enables eye contact to be maintained.

FIG. 9 shows apparatus for use in video conferencing in which a projector 52 projects an image onto a curved front projection screen 54. A person views the image on the screen 54 via a part-transmissive curved mirror 56. A video camera 58 is placed at eye level behind the part-transmissive curved mirror 56. The projector 52 and the screen 54 may also be positioned above the person and the mirror 56, with suitable selection of mirror orientation and shape.

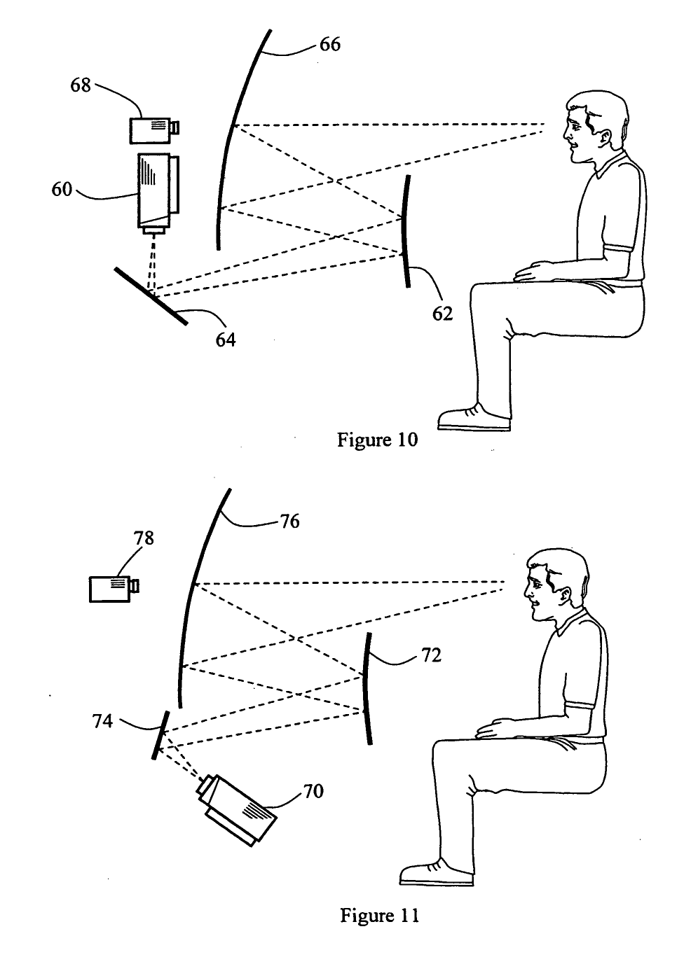

FIG. 10 shows apparatus for use in video conferencing in which a projector 60 projects onto a front projection screen 62, via a fold mirror 64. A video camera 68 is positioned behind a part-transmissive curved mirror 66, at eye level of the person. The apparatus shown in FIG. 10 demonstrates that the overall size of the apparatus can be reduced by the use of one or more fold mirrors.

FIG. 11 shows apparatus for use in video conferencing in which a projector 70 projects onto a front projection screen 72 via a fold mirror 74. A video camera 78 is positioned behind a part-transmissive curved mirror 76, at the eye level of the person.

Ideally, the image viewed by the person via the curved mirror should be produced on a curved surface to provide the best optical performance. However, if the desired field of view is not in excess of approximately 25°, in either the horizontal or vertical directions, then a flat image surface can be used without unacceptable distortion or other optical aberrations.

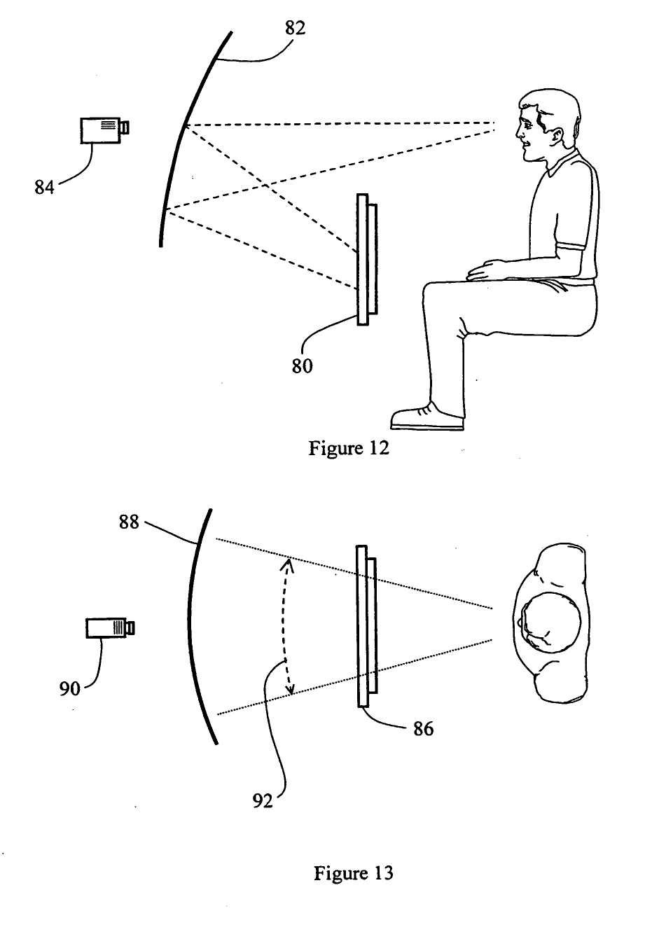

FIG. 12 shows apparatus for use in video conferencing in which a flat panel display 80 is viewed via a part transmissive curved mirror 82. A video camera 84 is positioned behind the part-transmissive curved mirror 82 at the eye level of the person.

FIG. 13 shows the apparatus of FIG. 12 viewed from above. As can be seen from FIG. 13, a flat panel display 86 is viewed by the person via a part-transmissive curved mirror 88. A video camera 90 is positioned behind the part transmissive curved mirror 88 at the eye level of the person. The limited field of view 92, typically less than 25°, is shown.

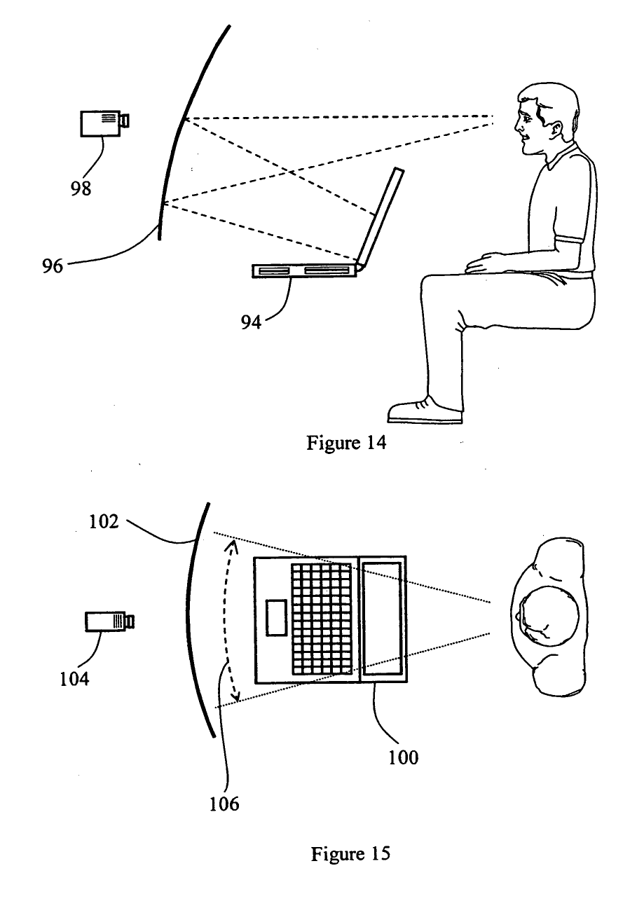

FIG. 14 shows a flat panel being viewed via a part-transmissive curved mirror 96. In this case, the flat panel is the display of a lap top computer 94. A video camera 98 is positioned behind the part-transmissive mirror 96, at the eye level of the person.

FIG. 15 shows apparatus like the apparatus of FIG. 14, viewed from above. A flat panel display of the lap top computer 100 is viewed via a part-transmissive curved mirror 102. A video camera 104 is positioned behind the part-transmissive curved mirror 102, at the eye level of the participant. The limited field of view 106, typically less than 25°, is shown.

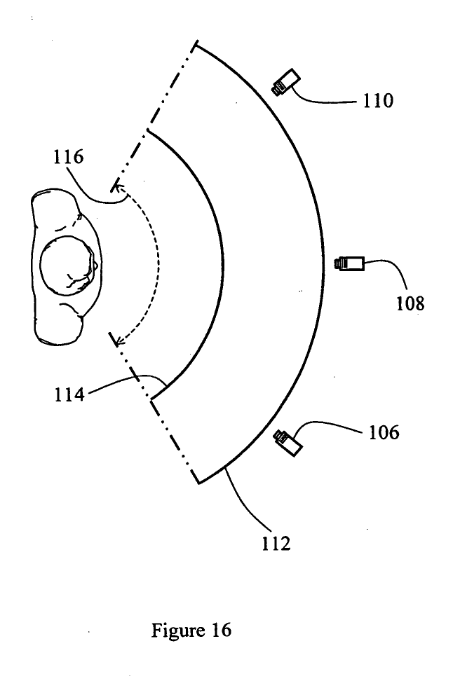

FIG. 16 shows an embodiment of the present invention in which the apparatus is such that a person at one location is able to communicate with other persons at more than one other remote location. The apparatus comprises a part-transmissive curved mirror 112 and a curved projection screen 114 which are extended to have a larger horizontal field of view 116, in this case approximately 120°. Video cameras 106, 108 and 110 are positioned at participant eye level behind the part-transmissive curved mirror 112. If a person turns to each camera, then that person will have eye to eye contact with each of the other persons at the other remote locations. Individual images of other persons at remote locations are displayed to coincide with each video camera. This can be done using three projectors projecting images onto the curved screen 114. Use of a common background of each location would allow continuity between the images. Alternatively, continuity between the images may be achieved by means of computer graphics or other video image manipulation.

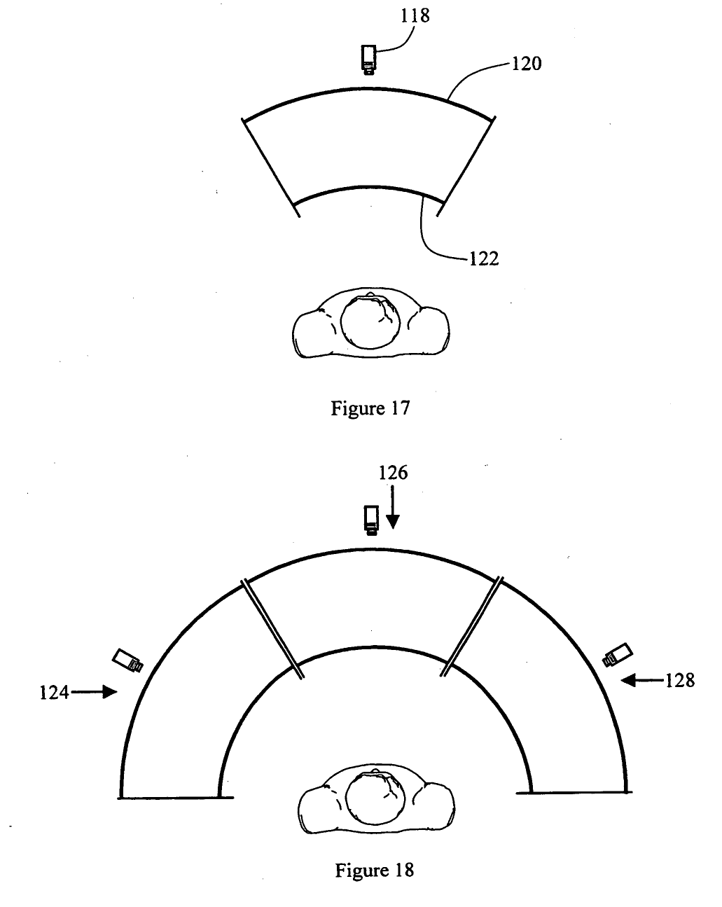

FIG. 17 shows apparatus for use in video conferencing which comprises a single one-participant module. A camera 118 is placed behind a part-transmissive curved mirror 120. A person views the image produced on a curved projection screen 122, via the part-transmissive curved mirror 120.

FIG. 18 shows three visual display modules of the type shown in FIG. 16. FIG. 18 shows how the three visual display models can be juxtaposed in order to form a display with a large field of view. More specifically, FIG. 18 shows three modules 124, 126 and 128 positioned to form the display. The display would not be continuous, but it would be adequate for the purposes of multiple remote location video conferencing.

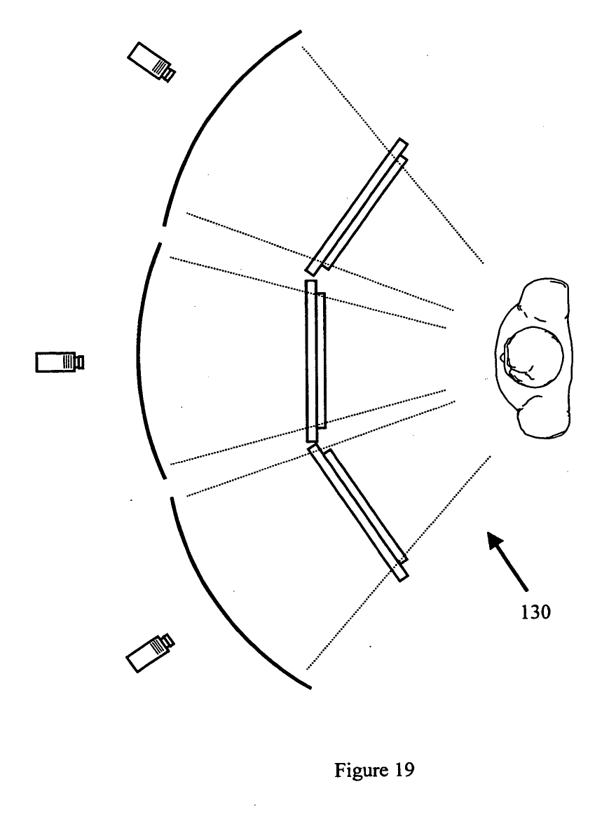

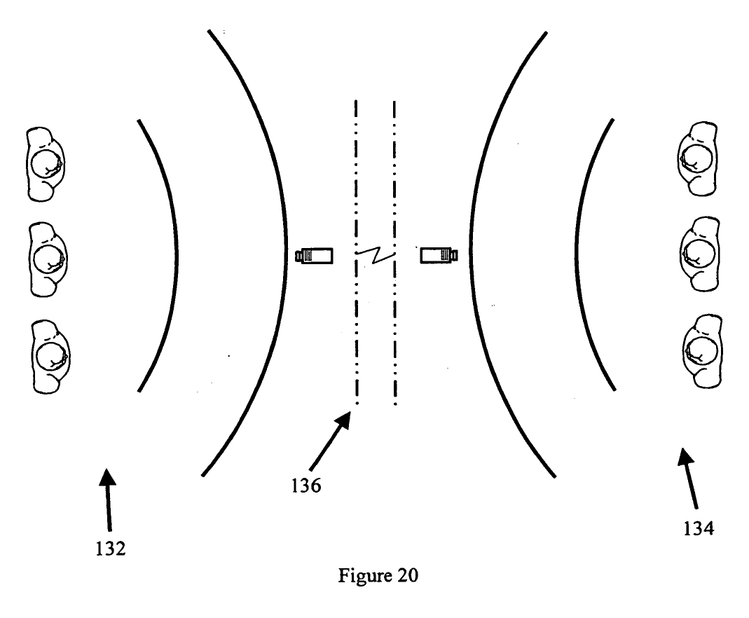

FIG. 19 illustrates how individual modules can be juxtaposed to form a multiple user interface 130, when using a flat panel display as the image source. As mentioned above, the field of view of a module that employs a flat panel display would normally be restricted to 25° or less. In order to achieve a degree of continuity between such modules, the curvature of the mirror can be less than the distance to the person, thus magnifying the image such that for each module, the total field of view visible by moving from side to side is greater than the instantaneous value as viewed from the centre.

As mentioned above, the apparatus of the present invention uses a part-transmissive curved mirror. Such part-transmissive curved mirrors normally have a viewing volume from within which the aberrations that occur are acceptable. The viewing volume depends on the radius of curvature of the mirror. The useful viewing volume increases as the radius increases. Therefore a display with a larger radius would enable more than one participant to use the display.

FIG. 20 shows visual displays 132 and 134 that incorporate large radius part-transmissive curved mirrors. These displays are linked by a suitable communications link 136. In the apparatus illustrated in FIG. 20, it is possible for more than one person to take part in a video conference at each location. The collimation characteristics of the visual display mean that eye contact would essentially be maintained between the participating persons. By using a combination of visual displays, it would be possible to realise a video conference with one person at a location communicating with several persons at a remote location.

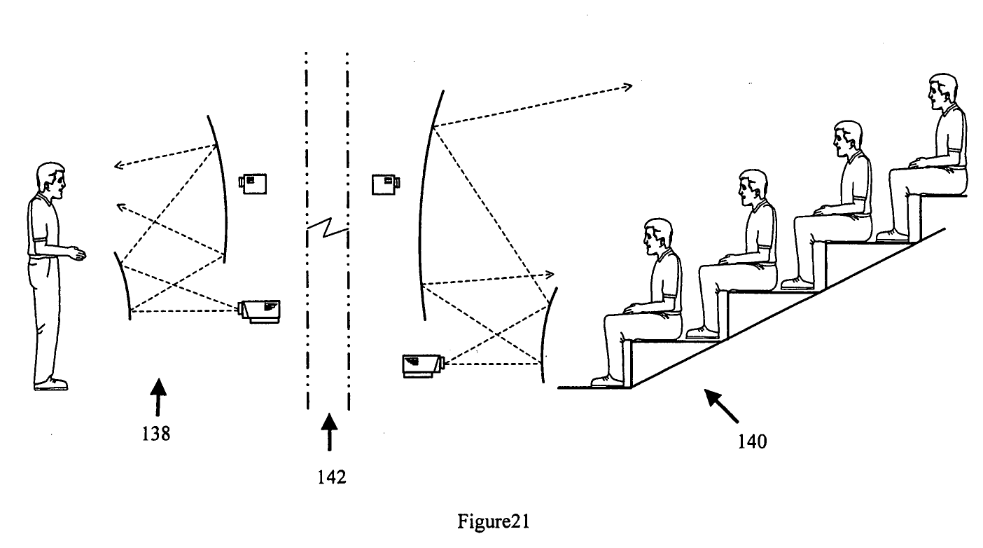

FIG. 21 shows one person at one location 138 communicating with more than one person at a remote location 140. This is effected using a suitable communications link 142. An example of a use of such a system is lecturer delivering a lecture to a remote audience.

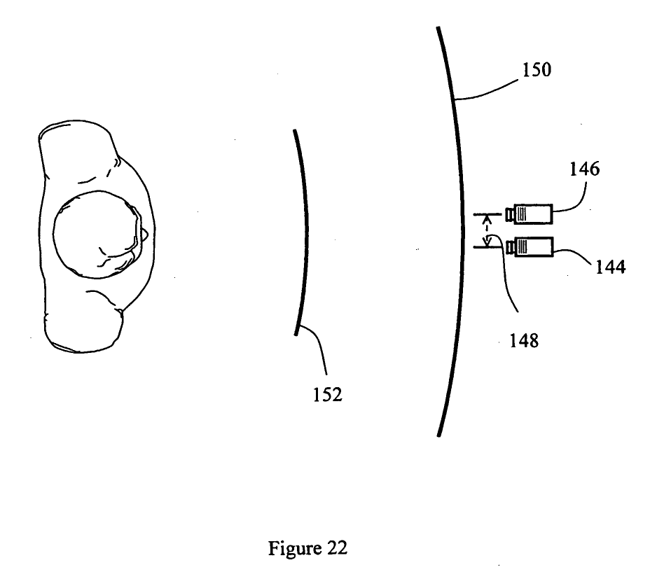

FIG. 22 illustrates how stereo images may be produced using apparatus of the present invention. More specifically, FIG. 22 shows two video cameras 144, 146 which are separated by distance equivalent. to the interocular distance 148 and which are placed behind a part-transmissive mirror 150.

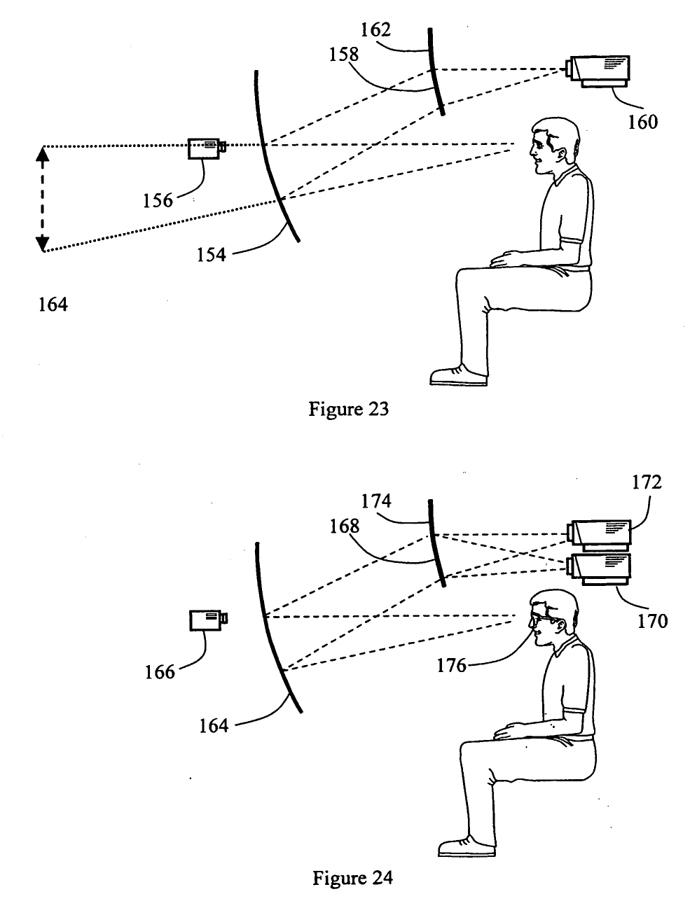

FIG. 23 shows how a part-transmissive curved mirror 154 magnifies an image 164 that is used by a person. A projector 160 projects an image 158 onto a rear projection screen 162. This image is then viewed by the person via the part-transmissive curved mirror 154. A video camera 156 is placed at eye level behind the part-transmissive curved mirror 154.

FIG. 24 shows a projector 170 and a projector 172 projecting stereo images onto a rear projection screen 174. Suitable known stereo image projection using either known passive or active means may be used to produce images 168 on the curved screen 174. The example of FIG. 24 employs passive means, whereby projector 170 emits light of one polarisation and projector 172 emits light of another separable polarisation. Light may be of circular or linear polarisation. The curved screen 174 is viewed by a person wearing compatible polarising glasses 176, via the part-transmissive curved mirror. A stereo display could also allow participating persons to view a shared object that could be inserted as an image of one or more displays in the conference such that the object could be viewed by the participating persons. The inclusion of a head or eye tracking system may be needed to compensate for movement so that shared objects do not appear to float.

It will be appreciated from the above description of various embodiments of the invention with reference to FIGS. 6 - 24 that the apparatus of the present invention is able to provide many advantages over known apparatus for use in video conferencing. With the apparatus of the present invention, it is possible to achieve eye contact which is required. Virtual round table meetings can be conducted with the required eye contact. The environment around a remote user is able to be observed.

It is to be appreciated that the embodiments of the invention described above with reference to the accompanying drawings have been given by way of example only and that modifications may be effected. Thus, for example, the apparatus may utilise an optical system which is adjustable such that the apparent image distance can be varied. Also, the magnification in the optical system means that live sized images can be produced from a relatively small image on the display surface. The display may be scalable to allow the trade between desired characteristics of the display such as compactness and viewing volume. High contrast can be obtained in the display by adjusting characteristics such as the screen gain or emission characteristics. Ambient light on the display surface can be limited by enclosing the display volume. The visual displays can be used as displays for other purposes such as computer displays, television or any other type of visual display. Various collimator arrangements may be employed, for example a tilted collimator arrangement, or a beamsplitter and curved mirror collimator.

1-24 (cancelled)

25. Apparatus for use in video conferencing, which apparatus comprises at least one video camera for providing a video image signal of at least one person taking part in a video conference, at least one display means on which the video image signal from a remote location is displayed, and at least one part-transmissive curved mirror which enables the person to view the display means with the video camera being positioned on a side of the part-transmissive curved mirror away from the person and at substantially eye level of the person, whereby persons using the apparatus for a video conference are able to maintain eye contact with each other.

26. Apparatus according to claim 25 in which the display means is a curved screen.

27. Apparatus according to claim 26 in which the curved screen is a curved projection screen, and in which the apparatus includes a projector for projecting the recording from the video camera as a display onto the curved projection screen.

28. Apparatus according to claim 27 in which the curved projection screen is a curved rear projection screen, and in which the projector projects the display onto a concave side of the rear projection screen.

29. Apparatus according to claim 28 in which the curved projection screen is a curved front projection screen, and in which the projector projects the display onto a convex side of the front projection screen.

30. Apparatus according to claim 27 and including at least one light path fold mirror, and in which the projector projects the display onto the curved projection screen via the fold mirror.

31. Apparatus according to claim 27 in which there are more than one of the projectors.

32. Apparatus according to claim 25 in which the display means is selected from the group consisting of an emissive display means, a cathode ray tube monitor, and a flat panel display means.

33. Apparatus according to claim 32 in which the display means is a flat panel display means, and in which the flat panel display means is selected from the group consisting of a liquid crystal flat panel display device, and an organic light emitting polymer display panel.

34. Apparatus according to claim 32 in which the flat panel display means is part of a lap top computer.

35. Apparatus according to claim 32 in which the flat panel display means is a plasma display panel.

36. Apparatus according to claim 25 in which the display means extends continuously in a horizontal direction such that the display means subtends a wider angle at the person.

37. Apparatus according to claim 25 in which the display means and the part-transmissive curve mirror are both extended continuously in a horizontal direction such that a wider-angle is subtended at the person.

38. Apparatus according to claim 25 in which the part-transmissive curved mirror is extended continuously in a horizontal direction such that the part-transmissive curved mirror subtends a wider angle at the person.

39. Apparatus according to claim 25 in which there are more than one of the display means, and in which the display means are arranged adjacent to each other and facing substantially away from the person.

40. Apparatus according to claim 25 in which two of the video cameras are positioned on the side of the part-transmissive curved mirror remote from the person, and in which the two video cameras are positioned with a horizontal separation such that a stereoscopic image signal of the person is made.

41. Apparatus according to claim 25 and including software for manipulating images such that the video image of the person is provided with desired orientation and distortion correction.

42. Apparatus according to claim 25 and including audio means for providing audio signals of the persons taking part in the video conference.

43. Apparatus according to claim 25 and including connection means whereby the visual displays are connected via a communications link providing means for transmitting audio and visual data between more than one of the display means, the communications link being provided by at least one local area network, a wide area network, multiple telephone lines, a high-speed data link, the Internet, a ISDN, or a wireless communications link.

44. Apparatus according to claim 25 in which the display means is a modular display means, whereby a plurality of the modular display means can be placed adjacent to each other in order to form an extended visual display.
